(19) United States
(12) Patent Application Publication
(10) Pub. No.: US 2014/0054519 A1
(43) Pub. Date: Feb. 27, 2014

(54) VEGETABLE DIELECTRIC FLUID FOR ELECTRICAL TRANSFORMERS

(71) Applicants: Augusto Parodi, Genova (IT); Leandro Marini, Ceranesi (IT); Salvatore Parrone, Genova (IT); Roberto Campi, Genova (IT)

(72) Inventors: Augusto Parodi, Genova (IT); Leandro Marini, Ceranesi (IT); Salvatore Parrone, Genova (IT); Roberto Campi, Genova (IT)

(73) Assignee: A & A Fratelli Parodi S.P.A., Campomorone (IT)

(21) Appl. No.: 13/983,845

(22) PCT Filed: Feb. 10, 2012
(86) PCT No.: PCT/EP12/52361

§ 371 Date: Nov. 13, 2013

(30) Foreign Application Priority Data
Feb. 14, 2011 (IT) 2011A000016

(51) Int. Cl. H01B 3/20

(52) U.S. Cl. CPC H01B 3/20
USPC 252/576; 252/579

(57) ABSTRACT

Composition of one or more vegetable oils intended as triglycerides of natural origin with an oleic acid (C18:1) content less than 75%, preferably less than or equal to 74% which composition can be used for preparing dielectric fluids to be used in electrical transformers.

The present invention relates to a composition of one or more oils suitable as dielectric fluid with significant qualities as regards resistivity, dielectric strength, biodegradability and oxidation resistance to be used within insulating and cooling systems typical of current transformers.

The dielectric fluids used in the electric industry generally are gases or liquids which act for cooling and insulating the parts in contact thereto.

Liquids used as dielectric fluids can have different origins.

Mineral oils derived from petroleum are mainly used as dielectric fluids.

Mineral oils are widely available, have good dielectric properties, cooling properties, a low viscosity at high temperatures and a good behaviour at very low temperatures. They further have a high oxidation stability.

Because of their special molecular structure that they have obtained over time, mineral oils are particularly stable when used in current transformers, thereby they are the most used fluids for this purpose.

Companies manufacturing mineral oils have also promoted the use of said oils ignoring the environmental impact, even where risks of being spilled in the environment were particularly high.

Due to their chemical composition they have a poor biodegradability and a spill in the environment of these oils can cause the ecosystem to be damaged even for many years. Mineral oils are highly combustible and this can be dangerous in the event of fire or explosion.

Current regulations about the use of dielectric fluids require fluids that are used to have a high flash point.

Moreover the fact that mineral oils are inadequate as regards the flash point, a characteristic that cannot be improved by adding additives, has led to the production and use of synthetic oils containing polychlorobiphenyls (PCBs), which are excellent fluids to be used in electrical transformers but they have a high environmental impact as they are not biodegradable.

This adverse characteristic has led to regulations that have stopped their production and have led them not to be used anymore, that is said fluids have been replaced into the transformers.

Due to a lack of alternatives, mineral oils have again gained ground, while leaving unresolved the problem of the environmental impact in case of accidental spill, and the risk related to the low flash point.

In the last years, the search for new liquids suitable as dielectric fluids has been speeded up thanks to a strong environmental awareness and to the carbon dioxide reduction policy.

The American patent U.S. Pat. No. 4,355,346 describes a capacitor wherein the dielectric fluid is completely biodegradable and it is made of 1,1-bis(3,4-dimethylphenyl)ethane.

The American patent U.S. Pat. No. 3,996,505 describes an electrical apparatus wherein the dielectric system comprises a polymeric film impregnated with biodegradable polybutene.

The English patent GB 1509681 describes a dielectric liquid made of a mixture of mono-halogenated diphenyl oxide and a mono-halogenated alkyl diphenyl oxide where the alkyl group contains from 1 to 20 carbon atoms. The liquid dielectric composition is substantially biodegradable.

The patent U.S. Pat. No. 4,284,522 describes a biodegradable composition to be used as a dielectric fluid formed from natural hydrocarbons and synthetic hydrocarbons.

The use of vegetable oils as dielectric fluids is also known.

Vegetable oils have been considered as suitable to be used as dielectric fluids by research studies because of their intrinsic qualities such as biodegradability, the high flash point and a good dielectric constant.

Vegetable oils have a high percent of triglyceride esters of saturated and unsaturated fatty acids.

Natural exters are obtained from oils with vegetable origin through suitable refining and purification processes.

In particular it is necessary to select this oil or a mixture of oils ignoring for example too much saturated or too much unsaturated oils which are in contrast with values suitable for obtaining a liquid to be used as dielectric fluid within the insulating and cooling system typical of current transformers.

However these oils can be used only when additives are suitably added thereto in order to avoid degradation or chemical attacks to the mechanical parts of the apparatus wherein they are used, in particular a current transformer.

The use of mixtures of one or more vegetable oils to be used within electrical transformers, with a high polyunsaturated acid content, in particular linoleic acid, or with a high monounsaturated acid content, in particular with an oleic acid content more than 75% is known.

Antioxidants and corrosion inhibitors available in the standard trade distribution are added, in various percentages, to these oils, which additives are not specific for the use only with vegetable oils for transformers.

The main advantages of the use of vegetable oils as dielectric fluids are their biodegradability, their possibility of being obtained from renewable natural sources, their non-toxicity, their high fire point and their low cost, if compared to other alternative substances with a high fire point such as synthetic esters.

However, vegetable oils or their derivatives are not free of problems in their use as dielectric fluids.

For example, it is important for the dielectric fluid based on vegetable oils to remain flowable even if it is subjected to low temperatures. Additives are usually used to reduce the freezing point (that is the temperature at which a liquid passes to the solid state) and to guarantee the dielectric fluid to be resistant even to the low temperatures.

One of the most important problems of vegetable oils is oxidation. Vegetable oils are polymerized when are exposed to oxygen, and the change in their properties can be an obstacle to the use of the vegetable oils as dielectric fluids. Moreover the problem of the oxidation of the dielectric fluids based on vegetable oils is emphasized in electrical apparatuses due to the catalytic activity of copper or of other metals present in this type of apparatuses.

In order to solve this problem synthetic antioxidants are usually used.

The international patent application WO 2008/113866 describes a biodegradable dielectric fluid free of antioxidant synthetic additives and comprising an oil or a mixture of vegetable oils with an oleic acid (C18:1) content greater than 75% and with a natural tocopherol content greater than 200 ppm, a metal deactivator being added to said mixture as an additive in a proportion less than 1%.

According to the above mentioned patent the problem of the oxidation is solved by using oils with a high oleic acid content, which oils are obtained by a refining process which allow natural tocopherols present in said vegetable oils in a high percentage to be preserved.

According to the above mentioned patent specific vegetable oils with a high oleic acid content and low linoleic acid content and which preserve their natural tocopherol content have enough antioxidant power to prevent non-biodegradable synthetic and antioxidant additives from being added.

The American patent application US2006/0030499 describes an electrical transformer with a dielectric fluid essentially composed of one or more vegetable oils containing from 0.1 % to 3% of one or more antioxidant compounds and wherein said dielectric fluid has an oxidative stability of 100 or more AOM hours (Active Oxygen Method).

The oleic acid content of the dielectric fluid is at least 75%. An oil with a high oleic acid content (80%) can be derived from plant seeds such as sunflower and canola which have been genetically modified.

The international patent application WO 2008/143830 describes a mixture to be used as dielectric fluid comprising at least a vegetable oil and at least an antioxidant, which mixture or which vegetable oil has a pour point less than −20° C. According to the above mentioned patent the vegetable oil is rapeseed oil. The composition described allows a dielectric fluid to be obtained which remain flowable even at low temperatures.

The patent application US 2002/004 9145 describes a dielectric fluid, based on vegetable oils derived from soybean and mais, chemically modified by at least a partial hydrogenation in order to increase the oxidation stability.

The patent EP 95024 9 describes a composition with a high oleic acid content to be used as dielectric fluid, which composition has an oleic acid content equal to at least 75%.

The oleic acid is a monounsaturated acid which occurs as glycerol ester in many vegetable oils such as sunflower oil, olive oil and safflower oil in high proportions (about 60%).

An oleic acid content greater 80% can be obtained from genetically modified plants and seeds.

Therefore the aim of the present invention is to provide a composition comprising at least an oil of vegetable origin to be used, alone or in combination with other substances, as a dielectric fluid and a method for obtaining such composition to be used as a dielectric fluid which fluid can be used in electrical apparatuses without environmental risks, said composition being non-toxic and more biodegradable than dielectric fluids based on mineral oils or synthetic oils and said composition and therefore said fluid being derivable from renewable sources.

The dielectric fluid shall have the following characteristics:
high oxidation stability,
a low pour point in order to work even at low operating temperatures,
a high viscosity index for an optimal viscosity at different operating temperatures,
anti-corrosion ability,
compatibility with resins, polymers, insulating and sealing materials,
maintaining their insulating and cooling characteristics even after chemical or physical changes that may occur in use.

The aims mentioned above are achieved by a composition of one or more vegetable oils intended as triglycerides of natural origin wherein said composition has an oleic acid (C18:1) content less than 75%, preferably less than or equal to 74%.

The dielectric fluid obtained from this composition meets specific requirements of the industry and/or has a behaviour like that of the existing fluids.

Moreover the dielectric fluid object of the present invention has a long life and it carries out its functions within a wide range of operating and environmental conditions.

Therefore the object of the present invention is a composition of one or more vegetable oils whose properties make it suitable to be used as dielectric fluid, a dielectric fluid and an electrical apparatus, in particular an electrical transformer comprising said dielectric fluid, the components of said apparatus being intended to transform the electrical voltages wherein the oil operates as an electrical insulator and as a heat dissipator.

Said dielectric fluid is economically advantageous as regards the production and use.

These and other characteristics and advantages of the present invention will be more clear from the following description and examples.

Usually vegetable oils have a high percentage of triglyceride esters of saturated or unsaturated fatty acids.

Pure oils are triglycerides of fatty acids with a chain of carbon atoms ranging from 6 to 22 carbon atoms.

When the carbon atom chain has no double bonds the fatty acid is defined as saturated (Cn:0). Chains with a single double bond are designated as monounsaturated (Cn:1), with two double bonds (Cn:2) as diunsaturated and so forth.

The oleic acid is a monounsaturated acid with 18 carbon atoms C18:1.

When the fatty acid is saturated the triglyceride is either a semi-solid or a liquid with a high freezing point. On the contrary unsaturated fatty acids produce oils with low freezing points. However, monounsaturated acids are preferred over diunsaturated or triunsaturated acids because the latter tend to make the oil more vulnerable to oxidation. The increase of the saturated fatty acids raises the pour point.

Oils with a high percentage of diunsaturated or triunsaturated acids can be used as fluids into electrical apparatuses but they quickly get oxidized.

The choice of the oil or of a mixture of oils to be used as dielectric fluids is for example based on their freezing point.

Therefore oils with high percentages of long chain saturated fatty acids are not very suitable, in particular lauric acid, myristic acid, palmitic acid, stearic acid.

Considering their disposition to oxidation the oils with high percentages of polyunsaturated acids such as the linoleic acid and the linolenic acid cannot be used as dielectric fluids.

Considering the disposition to oxidation of the vegetable oils due to:
the oil composition,
the contact of the oil with the oxygen present in the air,
the operating temperature,

the object of the present invention is a composition of one or more vegetable oils to be used as dielectric fluid which composition comprises hazelnut oil and/or macadamia nut oil and/or coconut oil as MCT (medium chain triglcerides) oil physically extracted from chemically unmodified coconut oil and/or high oleic sunflower.

The high oleic sunflower does not exist in nature but is derives from seeds or plants whose genetic code has been modified and/or selected.

The object of the present invention preferably is a composition of one or more oils intended as non OGM natural esters that is oils derived from plants or seeds that have not been genetically modified but the composition can contain or can be composed also of one or more oils derived from genetically modified and/or selected plants and/or seeds, since even the latter can be chemically and physically used as dielectric fluids.

Said composition of one or more oils is used alone or in combination with other substances for preparing a liquid to be used as dielectric fluid.

In the composition of one or more oils object of the present invention, intended as triglycerides of natural origin, there is provided:
a monounsaturated acid content in a particularly high or medium high percentage,
a high percentage content of medium and long chain acids.

Particularly in the oil composition object of the present invention predominant acids are:
oleic acid (C18:1),
palmitoleic acid (C16:1).

The composition can comprise, in small amounts:
linolenic acid (C18:3) and/or linoleic acid (C18:2).

According to the present invention:
the oleic acid content is less than 75%, preferably less than or equal to 74%,
the palmitoleic acid content ranges from 1% to 25%,
the linolenic acid content is less than 0.5%.

In one embodiment the oleic acid content is less than 75%, preferably less than or equal to 74% and/or the palmitoleic acid content is more than 2%.

Compositions of one or more vegetable oils are described below, which, according to the present invention, can be used as a base for preparing a dielectric fluid.

According to one embodiment the composition comprises a mixture of high oleic sunflower oil and macadamia nut oil. The high oleic sunflower oil content of said mixture ranges from 40% to 90% and the macadamia nut oil content ranges from 10% to 60%.

Preferably the macadamia nut oil content does not exceed 35%.

According to a preferred embodiment the mixture has a high oleic sunflower oil content of 74% and macadamia nut oil content of 26% and said mixture has an oleic acid C18:1 content of about 74% and a palmitoleic acid C16:1 content of about 7%. Said mixture is especially advantageous as regards production costs.

According to a further embodiment the composition comprises a mixture of hazelnut oil and of macadamia nut oil. Said mixture has a hazelnut oil content ranging from 40% to 90% and a macadamia nut oil content ranging from 10% to 60%.

Preferably the macadamia nut oil content does not exceed 35%.

According to a preferred embodiment the mixture has a hazelnut oil content of 74% and a macadamia nut oil content of 26% and said mixture has an oleic acid C18:1 content of about 74% and a palmitoleic acid C16:1 content of about 7%.

According to a further embodiment the composition comprises a mixture of high oleic sunflower oil and MCT oil physically extracted from chemically unmodified coconut oil. Said mixture has a high oleic sunflower oil content ranging from 60% to 95% and a MCT oil content ranging from 5% to 40%.

According to a preferred embodiment the mixture has a high oleic sunflower oil content of 90% and a MCT oil content of 10% and said mixture has an oleic acid C18:1 content of about 74%.

According to a further embodiment the composition comprises a mixture of hazelnut oil and MCT oil physically extracted from chemically unmodified coconut oil. Said mixture has a hazelnut oil content ranging from 60% to 95% and a MCT oil content ranging from 5% to 40%.

According to a preferred embodiment the mixture has a hazelnut oil content of 90% and a MCT oil content of 10% and said mixture has an oleic acid C18:1 content of about 74%.

The mixtures listed above are different from known oil mixtures for example mixtures of high oleic sunflower oil and of canola oil which have a oleic acid content ranging from 80% to 85%.

The macadamia nut oil is particularly advantageous for the aims of the present invention since it has a good palmitoleic acid content (monounsaturated acid C16:1) of about 20%.

Other compounds are rich in palmitoletic acid but are not suitable for the use as the base for producing dielectric fluids since they are rich in saturated acids:
avocado oil has a palmitoleic acid content of about 4-7% but it is rich in saturated acids as well,
the animal fatt has a palmitoleic acid content of about 2.5% but it is rich in saturated acids as well.

Obvisously it is possible to add at least a further oil preferably selected among high oleic sunflower oil, hazelnut oil, macadamia nut oil, MCT oil to the mixtures made of two oils described above which oil or which oils are added to the mixtures listed above in a variable percentage.

Additives, individually or in a mixture one with the other, can be added to the mixtures described above such as at least an antioxidant, at least a copper inhibitor, at least an acidity regulator, at least a pour point depressant.

The present invention therefore relates to:
a composition of one or more oils wherein the fatty acid component has an oleic acid (C18:1) content less than 75%, preferably less than or equal to 74%,
a composition of one or more oils wherein the fatty acid component has a palmitoleic acid content ranging from 1% to 25%,
a composition of one or more oils wherein the fatty acid component has a linolenic acid content less than 0.5%,
a dielectric fluid comprising a composition of one or more oils as described above,
electrical apparatuses comprising said dielectric fluid,
the use of a dielectric fluid as described above as the fluid cooling and insulating parts of electrical apparatuses.

At least one additive can be added to said composition of one or more oils.

The dielectric fluid object of the present invention comprises the composition of one or more vegetable oils as described above and can further comprise one or more additives.

The dielectric fluid object of the present invention has the following physical characteristics:
a dielectric strength, according to the analytical method IEC 60156, of at least 35 KV, in particular more than 40 KV,
a dissipation factor, according to the analytical method ASTM D924, less than 0.04% at 25° C., in particular less than 0.02% at 25° C.,
a pour point, according to the analytical method ASTM D97, of at least −17° C.,
a flash point, according to the analytical method AOCS Tn1a-64, of at least 250° C., in particular of at least 300° C.,
an acid number, according to the analytical method AOCS Cd3d-63, less than or equal to 0.05 mgKOH/g,
a viscosity, according to the analytical method ASTM D7042, ranging from 35 to 42 cSt at 40° C.,
an electrical conductivity less than 1 pS/m at 25° C. in particular 0.15 pS/m or a lower one.

Oils of the present invention comprise oils intended as triglycerides of natural origin, said oils being provided in different amounts into the mixtures but always with an oleic acid content less than 75%, preferably less than or equal to 74%.

Additives comprise antioxidants, copper

inhibitors, acidity and moisture regulators, pour point depressants that is an additive serving for lowering the pour point temperature of the product.

The composition, in particular the composition to be used as dielectric fluid, can comprise at least an antioxidant and/or at least a copper inhibitor, and/or at least an acidity and moisture regulator and/or at least a pour point depressant.

According to the present invention the additive content is always less than 5%.

According to a preferred embodiment the composition of one or more oils comprises tert-butylhydroquinone (TBHQ) as the antioxidant additive, substituted benzotriazole as the copper inhibitor, a polymethacrylate as the pour point depressant, a carbamide as the moisture and acidity regulator.

These additives are commercially available on the market and companies manufacturing them operate worldwide.

In particular additives are available, even if under different trade names, at Rhom & Haas, Afton Chemical, RheinChemie, Lubrizol, Eastman.

If necessary oxidation inhibitors can be added to the oil or oils.

Butylahydroxyanisole (BHA), butylhydroxytoluol (BHT) and tert-butylhydroquinone (TBHQ) are commonly used as antioxidant.

In the liquid to be used as dielectric fluid object of the present invention the antioxidants listed above are used individually or in a mixture one with the other, with percentages ranging from 0.1 to 2%.

Tert-butylhydroquinone (TBHQ) is specifically used.

TBHQ is added in an amount ranging from 0.1 to 0.5%, particularly 0.3%.

The oxidation stability of the oil, according to standard IEC 61125 at 48 hours, is defined by AOM or OSI methods, known in the prior art.

The provision of oxidation inhibitors is not always necessary since the oxidation process may be not critical thanks to the use of the dielectric fluid in an insulated environment, not in contact with air.

The copper is constantly provided in electrical transformers. Despite good performances the voltage transformation always produces heat which is transferred to the present fluid due to the contact with the copper: such condition is particularly harmful for the fluid since the copper is known to have a good catalytic effect on the oxidation. Thus it results that it is necessary to add to the oil or oils also copper inhibitors such to reduce the oxidative catalysis effect of copper in the electrical apparatuses.

The additives that are used are the benzotriazole derivatives and are available on the market.

The fact of adding one or more benzotriazole derivatives is efficacious even if they are added in small percentages to the electrical insulating and cooling fluid.

In the liquid to be used as dielectric fluid object of the present invention copper inhibitors, particularly the inhibitors described above, such as substituted triazole, are used individually or in a mixture one with the other, with percentages lower than 0.5% in particular 0.1%.

In order to meet enviromental conditions wherein dielectric fluid operate, it is necessary also to add pour point depressants.

Commercially available products can be used which are compatible with vegetable oils.

An amount ranging from 0.1 to 1.5% of at least one pour point depressant is added to the mixture of one or more oils.

Low percentages are enough for bringing down the pour point for example from −10 to −15° C.

The pour point depressant can be polymethacrylate (PMA).

In particular it is possible to add Viscoplex® 10-310 by Rohmax company, specifically an amount equal to 1% of the bulk.

With reference to the standard operating conditions of a transformer, the possibilities that the dielectric fluid can absorb water and/or moisture of the air are practically negligible.

However in special cases if the transformer is operating under extreme loading conditions, pyrolysis events cannot be excluded due to electric discharge arcs.

The phenomenon can thus generate neoformation acidity and moisture. In these cases it is advantageous to previously add to the mixture of oils object of the present invention a certain amount of at least a moisture and acidity regulator which actually chemically inactivates two potential dangers able to seriously compromise the operation of the transformer.

Therefore a carbamide in percentages ranging from 0.3% to 1.5% is further added as an additive to the mixture of oils to be used as dielectric fluid.

In particular ADDITIN® RC 8500 by RheinChemie is added, specifically an amount of 0.8% of the bulk.

According to the present invention one or more vegetable oils, in particular a mixture of oils wherein the total percentage of oleic acid is less than 75%, preferably less than or equal to 74%, are used for producing a composition of one or more oils with chemical/physical properties which make it suitable for producing a dielectric fluid, by adding one or more additives.

The present invention relates therefore to dielectric fluids, electrical apparatuses comprising said dielectric fluids and to the use of said fluids for insulating and cooling components of said electrical apparatuses.

The present invention relates also to a method for treating RDB (refined, bleached, and deodorized) oils such to make them suitable, by a physical refining, to be used in mixtures for preparing dielectric fluids.

The term RDB vegetable oil means a vegetable oil that has been refined, bleached and deodorized according to known techniques.

Said RDB oils are known in the prior art.

Such vegetable oils can be treated during the refining process with particular methods in order to obtain oils suitable to be used according to the present invention that is in order to remove contaminants that can compromise the use as dielectric fluids.

Oils are purified so as they can be used in electrical apparatuses.

In particular all the non-oil fractions provided in crude oils can be removed by natural or synthetic silica in combination with filtration aids.

The refining of the vegetable oil provides:
extraction of the oil from seeds by means of solvents or physical means;
degumming for removing from the compound the gum fibres, complex carbohydrates, phospholipids;
deacidification by caustic soda in order to lower the acidity;
bleaching by bleaching earths in order to remove clorophyl and betacarotene pigments, and possible soap residues of substances formed in the previous steps;
filtration by means of filter press or the like to remove earths. Some neoformation molecules which can be formed during the refining process, such as soaps of alkaline earth metals, and in particular sodium or potassium soaps, are almost all retained by additive bleaching earths (TDA),
deodorization, by vacuum distillation at 240-270° C., in order to remove the last aromatic substances, the last free fatty acids and some molecules generated by the previous steps. This step is necessary in order to obtain by a physical means, values of the acid number N.A. which are particularly small or anyway always less than 0.1.

Said value is particularly important for the application purposes provided for said oils.

A fair amount of molecules escaped from the filtration system are still present within the oil, making it necessary to seize them through silicons and an additional filtration process, by means of which almost all the substances are retained.

The method for treating vegetable oils according to the present invention provides from 1 to 3% of synthetic silica, of the Grace® type, to be added downstream of the known deodorization treatment.

The treatment by synthetic silica occurs at temperatures ranging from 80 to 100° C. into an agitated reactor and with a residual pressure level less than 50 mbar, such to make the system as anhydrous and consequently to make it particularly active for removing undesired substances that is particles deriving from the processing of oils in order to obtain RDB oils

After the silica treatment there is at least a step for filtrating said oil by silica preferably through one or more filter papers having different retention efficiency rates.

At the end of said treatments the oil or the mixture of oils is again tested as regards the parameter of the contamination of foreign particles in the oil.

In particular by means of a laser particle-counter which measures the amount and size of particles or molecules a class is given to the oil according to the standard NAS 1638.

If the oil is within high NAS classes the oil is further filtrated by means of filter papers with a more and more fine rate, without adding again silica.

In particular there is provided at least an additional filtration step by means of one or more filter papers having different retention efficiency rates, that is filter papers more and more selective or fine, such to increase the retention efficiency at each filtration step.

This treatment to which the vegetable oil is subjected guarantees the high purity of the dielectric fluid prepared with the mixture of oils object of the present invention since it allows undesired substances to be removed such as organometallic molecules and water.

The oil prepared in this way will not produce deposits, which often occur also with refined oils.

According to the present invention the composition of one or more oils obtained by the method object of the present invention belongs to a NAS class, according to standard NAS 1638, always lower than class 7.

Moreover the composition of one or more oils obtained with the method object of the present invention has a water content less than 100 ppm.

According to an embodiment the dielectric fluid comprises a mixture of high oleic sunflower oil and macadamia nut oil.

Said mixture can have a high oleic sunflower oil content ranging from 40% to 90% and a macadamia nut oil content ranging from 10% to 60%.

Preferably the macadamia nut oil content is not more than 35%.

According to a preferred embodiment the mixture has a high oleic sunflower oil content of 74% and a macadamia nut oil content of 26% and said mixture has an oleic acid C18:1 content of about 74% and a palmitoleic acid C16:1 content of about 7%.

Said dielectric fluid, which comprises a mixture of high oleic sunflower oil and macadamia nut oil, has at least one of the following properties:
a dielectric strength, according to the analytical method IEC 60156, of at least 35 KV, in particular 43.3 KV,
a dissipation factor, according to the analytical method ASTM D924, less than 0.04% at 25° C., in particular 0.004% at 25° C.,
a pour point, according to the analytical method ASTM D97, of at least −17° C.,
a flash point, according to the analytical method AOCS Tn1a-64, of at least 250° C., in particular of 325° C.,
an acid number, according to the analytical method AOCS Cd3d-63, of 0.05 mgKOH/g,
a viscosity, according to the analytical method ASTM D7042, of about 41.8 cSt at 40° C.,
an electric conductivity less than 1 pS/m at 25° C. in particular 0.15 pS/m or a lower one.

According to a further embodiment the dielectric fluid comprises a mixture of hazel nut oil and macadamia oil.

Said mixture can have a hazelnut oil content ranging from 40% to 90% and a macadamia nut oil content ranging from 10% to 60%.

Preferably the macadamia nut oil content is not more than 35%.

According to a preferred embodiment the mixture has a hazelnut oil content of 74% and a macadamia nut oil content of 26% and said mixture has an oleic acid C18:1 content of about 74% and a palmitoleic acid C16:1 content of about 7%.

Said dielectric fluid, which comprises a mixture of hazelnut oil and macadamia nut oil, has at least one of the following properties:
a dielectric strength, according to the analytical method IEC 60156, of at leat 35 KV, in particular 85.6 KV,
a dissipation factor, according to the analytical method ASTM D924, less than 0.04% at 25° C., in particular 0.02% at 25° C.,
a pour point, according to the analytical method ASTM D97, of at least −16° C.,
a flash point, according to the analytical method AOCS Tn1a-64, of at least 250° C., in particular of 305° C.,
an acid number, according to the analytical method AOCS Cd3d-63, of 0.05 mgKOH/g,
a viscosity, according to the analytical method ASTM D7042, of about 41 cSt at 40° C.,
an electrical conductivity less than 1 pS/m at 25° C. in particular 0.15 pS/m or a lower one.

The dielectric fluids described above can contain one or more additives, preferably a mixture of the following additives:
tert-butylhydroquinone (TBHQ) in an amount ranging from 0.1 to 0.5%, in particular 0.3% as the antioxidant additive,
substituted benzotriazole in an amount ranging from 0.1 to 0.5%, in particular 0.1% as the copper inhibitor,
polymethacrylate, in particular Viscolpex® 10-319 in an amount ranging from 0.1 to 1.5%, in particular 1% as the pour point depressant,
carbamide RC 8500® in an amount ranging from 0.3 to 1.5%, in particular 0.8% as the moisture and acidity regulator.

### EXAMPLE 1

A mixture of RDB refined (that is refined, bleached and deodorized) oils containing 74% of hazelnut oil and 26% of macadamia oil is analyzed by a PODS (Portable Oil Diagnostic System) laser particle-counter by Hach Ultra Analytics USA.

According to the standard NAS 1638 the mixture is classified as class 6.

The amount of contaminants provided in 100 ml of the mixture of oils therefore is 16000 particles from 5 to 15 micron, 2850 particles from 15 to 25 micron, 506 particles from 25 to 50 micron, 90 particles from 50 to 100 micron, 16 particles above 100 micron.

Since it is not possible to classify the origin and the composition of each individual particle, due to the fact that the “non-oil” substances, that is substances which are part of an oil but are not triglycerides, except for additives, provided in the dielectric fluid are a potential reason for a lowering in the dielectric properties, the mixture of vegetable oils is subjected to a treatment by synthetic silica of the Grace® type or the like as described above.

After the filtration the mixture is again analyzed by the laser particle-counter and it is classified as class 4 according to the standard NAS 1638.

The amounts of contaminants present in 100 ml of the mixture of oils therefore is 4000 particles from 5 to 15 micron, 712 particles from 15 to 25 micron, 126 particles from 25 to 50 micron, 22 particles from 50 to 100 micron, 4 particles above 100 micron.

### EXAMPLE 2

A mixture of refined RDB (refined, bleached and deodorized) oils containing 74% of hazelnut oil and 26% of macadamia nut oil is analyzed by a PODS (portable Oil Diagnostic System) laser particle-counter by Hach Ultra Analytics USA.

According to the standard NAS 1638 the mixture is classified as class 7.

The electrical conductivity is also measured and it is equal to 0.75 pS/m.

The mixture is subjected to filtration as described in the example 1.

The mixture is subjected to a further filtration according to the example 1.

After the second filtration the mixture is again analyzed with the laser particle-counter and according to the standard NAS 1638 it is classified as class 3 while the electrical conductivity measured is equal to 0.15 pS/m.

These examples show that RDB oils treated with synthetic silica and subjected to one preferably to several filtrations, improve their NAS class: the filtration allows further amounts of particulate, made of organometallic molecules and water to be retained. As a consequence also the value of the electrical conductivity improves and makes it possible to use this mixture of oils as a dielectric fluid.

### EXAMPLE 3

A mixture of refined RDB (refined, bleached and deodorized) oils containing 74% of hazelnut oil and 26% of macadamia nut oil treated as in the example 2 is analyzed.

Especially the value of the acid number according to AOCS Cd3d-63 method, the viscosity value according to ASTM D7042 method are analytically measured.

The acid number is 0.05.

The viscosity at 40° C. is 41.0 cSt.

The same mixture is subjected to the oxidation test by Rancimat 617 Methron apparatus according to IEC 61125 method.

At the end of the test the values of the acid number and viscosity are again tested as follows:

| | Acid number | |
|---|---|---|
| Test length | (mgKOH/g) | Viscosity (cSt) |
| 48H | 12.3 | 174.3 |

### EXAMPLE 4

Antioxidants, copper inhibitors, pour point depressants and a moisture and acidity regulator are added to a mixture of refined RDB (refined, bleached and deodorized) oils containing 74% of hazelnut oil and 26% of macadamia nut oil treated as in the example 2.

As the antioxidant one of the following compounds is typically used: butylhydroxyanisole (BHA), butylhydroxytoluol (BHT) and tert-butylhydroquinone (TBHQ).

As copper inhibitors benzotriazoles are typically used.

As pour point depressants polymethacrylates are typically used.

As acidity and moisture regulator a carbamide is typically used.

In particularly the tert-butylhydroquinone (TBHQ) by Eastman company in an amount ranging from 0.1 to 0.5%, in particular 0.3 % is used as the antioxidant.

The substituted benzotriazole by Lubrizol company in an amount ranging from 0.1 to 0.5% in particular 0.1% is used as the copper inhibitor.

Viscoplex 10-319 by Rhomax in an amount ranging from 0.1 to 1.5 %, particularly 1% is used as pour point depressant.

The compound RC 8500 by Rheinchemie company in an amount ranging from 0.3% to 1.5%, particularly 0.8% is used as the acidity and moisture regulator.

The mixture of oils with the additives is analytically tested in order to define the value of the acid number according to AOCS Cd3d-63 method and the viscosity value according to ASTM D7042 method.

The acid number is 0.05.

Viscosity at 40° C. is 41 cSt.

The same mixture is subjected to the oxidation test by Rancimat 617 Metrohm apparatus according to IEC 61125 method.

At the end of the test the values of the acid number and viscosity are again tested as follows:

| | Acid number | |
|---|---|---|
| Test length | (mgKOH/g) | Viscosity (cSt) |
| 48H | 0.20 | 41.9 |
| 164H | 0.29 | 42.4 |

### EXAMPLE 5

A mixture of oils comprising 74% of high oleic sunflower oil and 26% of macadamia nut oil is treated and filtrated as described above and then at least a copper inhibitor and at least an antioxidant as in the example 4 are added thereto.

The mixture of oils is analytically tested as regards the value of the acid number according to AOCS Cd3d-63 method and as regards the viscosity value according to ASTM D7042 method.

The acid number is 0.05.

The viscosity at 40° C. is 41.8 cSt.

The same mixture is subjected to the oxidation test by Rancimat 617 Methrom apparatus according to IEC 61125 method.

At the end of the test the values of the acid number and viscosity are again tested as follows:

| | Acid number | |
|---|---|---|
| Test length | (mgKOH/g) | Viscosity (cSt) |
| 48H | 0.30 | 43.2 |

The chemical physical characteristics of the dielectric fluids composed of a mixture of hazelnut oil and macadamia nut oil and of a mixture of high oleic sunflower oil and macadamia nut oil are shown below.

| | | | | High oleic |
|---|---|---|---|---|
| | | | Hazelnut- | sunflower- |
| | ANALYTICAL | Unit of | macadamia | macadamia |
| | METHOD | measure | nut | nut |
| Dielectric | IEC 60156 | kV | 85.6 | 43.3 |
| strength | | | | |
| Dissipation | ASTM D924 | % | 0.02 | 0.004 |
| factor | | | | |
| 25° C. | | | | |
| Pour point | ASTM D97 | ° C. | −16 | −17 |
| Flash point | AOCS Tn1a- | ° C. | 305 | 325 |
| | 64 | | | |
| Acid number | AOCS Cd3d- | mgKOH/g | 0.05 | 0.05 |
| | 63 | | | |

As described above the present invention relates also to an electrical apparatus comprising a fluid intended for cooling and insulating the components of said apparatus.

The electrical apparatus can be an electrical transformer, an electrical capacitor, a power supply cable or the like.

Obviously the fluid object of the present invention can be used in any apparatus wherein a cooling and/or insulating fluid with the characteristics described above is required.

1. A dielectric fluid composition comprising one or more vegetable oils, said oils being triglycerides of natural origin, characterized in that said composition has
(i) an oleic acid (C18:1) content less than 75%, preferably less than or equal to 74%,
(ii) a palmitoleic acid (C16:1) content ranging from 1% to 25%, preferably more than 2%,
(iii) linolenic acid (C16:1) content less than 0.5% and
in that the composition belongs to a NAS class lower than class 7, according to NAS 1638 standard.

2. (canceled)

3. (canceled)

4. (canceled)

5. The composition according claim 1 characterized in that it has a water content less than 100 ppm.

6. The composition according claim 5, characterized in that it comprises hazelnut oil, macadamia nut oil, MCT (medium chain triglycerides) oil physically extracted from chemically unmodified coconut oil, high oleic sunflower, said oils being provided individually or in a mixture of two or more oils.

7. The composition according to claim 6 characterized in that it comprises:
a mixture of high oleic sunflower oil and macadamia nut oil, wherein the high oleic sunflower oil content ranges from 40% to 90% and the macadamia nut oil content ranges from 10% to 60%, preferably the macadamia nut oil content being not more than 35%, or
a mixture of hazelnut oil and macadamia nut oil, wherein the hazelnut oil content ranges from 40% to 90% and the macadamia nut oil content ranges from 10% to 60%, preferably the macadamia nut oil content being not more than 35%.

8. (canceled)

9. The composition according to claim 7, characterized in that it comprises:
a mixture of high oleic sunflower oil and MCT oil, wherein the high oleic sunflower oil content ranges from 60% to 95% and the MCT oil content ranges from 5% to 40% or
a mixture of hazelnut oil and MCT oil, wherein the hazelnut oil content ranges from 60% to 95% and the MCT oil content ranges from 5% to 40%.

10. (canceled)

11. The composition according to claim 7, characterized in that said mixture has a high oleic sunflower oil content or hazelnut oil content of 74% and a macadamia nut oil content of 26% which mixture has an oleic acid (C18:1) content of about 74% and a palmitoleic acid (C16:1) content or about 7%.

12. The composition according to claim 9, characterized in that said mixture has a high oleic sunflower oil content or hazelnut oil content of 90% and a MCT oil content of 10% which mixture has an oleic acid (C18:1) content of about 74%.

13. The composition according to claim 12, characterized in that at least a further oil preferably selected among high oleic sunflower oil, hazelnut oil, macadamia nut oil MCT (medium chain triglycerides) oil physically extracted from chemically unmodified coconut oil is added to the mixtures made of two oils.

14. A method for preparing a composition which method provides the treatment of at least a refined, bleached and deodorized (RDB) oil comprising the following steps:
adding, to the RDB oil or mixture of RDB oils, synthetic silica in an amount ranging from 1% to 3% into an agitated reactor at a temperature ranging from 80 to 100° C. and with a residual pressure level less than 50 mbar,
at least a filtration preferably through one or more filter papers having different retention efficiency rates, such to retain undesired substances such as organometallic molecules and water.

15. The method according to claim 14 characterized in that it further comprises the following steps:
a qualitative analysis of the oil or mixture of oils, in particular a measurement of the amount and size of the particles present into the oil or in the mixture of oils in order to define the class to which it belongs according to the NAS 1638 standard,
at least one further filtration step by means of one or more filter papers having different retention efficiency rates such to increase the retention efficiency at each filtration step, wherein said at least one further filtration step does not provide further synthetic silica to be added.

16. (canceled)

17. The dielectric fluid composition according to claim 13 and further comprising at least one additive selected from an antioxidant additive, a copper inhibitor, a pour point depressant and a moisture and acidity regulator, or a mixture thereof, wherein the additive content is always less than 5%.

18. The dielectric fluid composition according to claim 17, characterized in that it has one or more of the following physical characteristics:
a dielectric strength, according to the analytical method IEC 60156, of at least 35 KV, in particular more than 40 KV,
a dissipation factor, according to the analytical method ASTM D924, less than 0.04% at 25° C., in particular less than 0.02% at 25° C.,
a pour point according to the analytical method ASTM D97, of at least −17° C.,
a flash point, according to the analytical, method AOCS Tn1a-64, of at least 250° C., in particular of at least 300° C.,
an acid number, according to the analytical method AOCS Cd3d-63, less than or equal to 0.05 mgKOH/g,
a viscosity, according to the analytical method ASTM D7042, ranging from 35 to 42 cSt at 40° C.,
an electrical conductivity less than 1 pS/m at 25° C. in particular 0.1.5 pS/m or a lower one.

19. (canceled)

20. The dielectric fluid composition according to one or more of the preceding claim 17, characterized in that it comprises one or more antioxidant additives in amounts ranging from 0.1% to 2%, selected from the group consisting of butylhydroxyanisole (BHA), butylhydroxytoluol (BHT) and tertbutylhydroquinone (TBHQ), said additive being preferably tert-butylhydroquinone (TBHQ) in an amount ranging from 0.1 to 0.5%, particularly preferably 0.3%.

21. The dielectric fluid composition according to claim 17, characterized in that it comprises:
one or more benzotriazole derivatives as copper inhibitors in a percentages lower than 0.5%, preferably 0.1%, or
at least a pour point depressant such as polymethacrylate (PMA) in an amount ranging from 0.1% to 1.5%, or
at least a moisture and acidity regulator, such as a carbamide in an amount ranging from 0.3% to 1.5%.

22. (canceled)

23. (canceled)

24. The dielectric fluid composition according to claim 21 characterized in that it comprises a mixture of high oleic sunflower oil and macadamia nut oil, and which dielectric fluid has at least one of the following properties:
a dielectric strength, according to the analytical method IEC 60156, of at least 35 KV, in particular 43.3 KV,
a dissipation factor, according to the analytical method ASTM D924, less than 0.04% at 25° C., in particular 0.004% at 25° C.,
a pour point, according to the analytical method ASTM D97, of at least −17° C.,
a flash point, according to the analytical method AOCS Tn1a-64, of at least 250° C., in particular of 325° C.,
an acid number, according to the analytical method AOCS Cd3d-63, of 0.05 mgKOH/g,
a viscosity, according to the analytical method ASTM D7042, of about 41.8 cSt at 40° C.,
an electric conductivity less than 1 pS/m at 25° C. in particular 0.15 pS/m or a lower one.

25. The dielectric fluid composition according to claim 21 characterized in that it comprises a mixture of hazelnut oil and macadamia nut oil, and which dielectric fluid has at least one of the following properties:
a dielectric strength, according to the analytical method IEC 60156, of at least 35 KV, in particular 85.6 KV,
a dissipation factor, according to the analytical method ASTM D92, less than 0.04% at 25° C., in particular 0.02% at 25° C.,
a pour point, according to the analytical method ASTM D97, of at least −16° C.,
a Hash point, according to the analytical method AOCS Tn1a-64, of at least 250° C., in particular Of 305° C.,
an acid number, according to the analytical method AOCS Cd3d-63, of 0.05 mgKOH/g,
a viscosity, according to the analytical method ASTM D7042, of about 41 cSt at 40° C.,
an electrical conductivity less than 1 pS/m at 25° C. in particular 0.15 pS/m or a lower one.

26. The dielectric fluid according to claim 25 characterized in that it comprises a mixture of one or more additives, such as:
tert-butylhydroquinone (TBHQ) in an amount ranging from 0.1 to 0.5%, in particular 0.3% as the antioxidant additive,
substituted benzotriazole in an amount ranging from 0.1 to 0.5%, in particular 0.1% as the copper inhibitor,
polymethacrylate, in particular Viseoplex (R) 10-319 in an amount ranging from 0.1 to 1.5%, in particular 1% as the pour point depressant,
carbamide RC 8500 (R) in an amount ranging from 0.3 to 1.5%, in particular 0.8% as the moisture and acidity regulator.

27. An electrical apparatus comprising a dielectric fluid composition according to one or more of the preceding claim 26, wherein said electrical apparatus is an electrical transformer, an electrical capacitor, a power supply cable or the like. supply cable or the like.

28. (canceled)
